(19) United States
(12) Patent Application Publication
(10) Pub. No.: US 2018/0292047 A1
(43) Pub. Date: Oct. 11, 2018

(54) PRESSURE CONTAINER FOR STORING GASES OR LIQUIDS UNDER PRESSURES ABOVE 200 BAR

(71) Applicant: REHAU AG + CO, Rehau (DE)

(72) Inventors: Thomas LANZL, Marktredwitz (DE); Kevin WILD, Erlbach (DE); Andreas GRUHL, Dresden (DE)

(21) Appl. No.: 15/762,805

(22) PCT Filed: Sep. 3, 2016
(86) PCT No.: PCT/EP2016/001492

§ 371 Date: Mar. 23, 2018

(30) Foreign Application Priority Data
Sep. 24, 2015 (DE) 202015105057.7
Nov. 2, 2015 (DE) 202015105815.2

(51) Int. Cl. F17C 1/06

(52) U.S. Cl. CPC F17C 1/06; F17C 2201/0109; F17C 2203/012; F17C 2260/011; F17C 2221/035; F17C 2223/0153; F17C 2223/036; F17C 2221/033

(57) ABSTRACT

The present invention relates to a pressure container for storing gases or liquids under pressures above 200 bar, comprising an elongate storage element having at least one rotationally symmetrical, preferably conical and/or cylindrical, central portion, a plurality (N) or number (N) of individual layers (n=1 to N) which each have at least one braided or wound reinforcing fibre, preferably at least two braided or wound reinforcing fibres, wherein the individual layers (n=1 to N) lie over one another in a local sequence along a perpendicular (S) to the axis of rotation of the central portion, and wherein an inner starting layer (n=1) surrounds a hollow body arranged within the storage element or forms said hollow body, and wherein an end layer (n=N) arranged above the starting layer (n=1) is provided, and wherein the reinforcing fibre or the reinforcing fibres in each of the individual layers (n=1 to N) has or have a layer-dependent fibre angle φₙ relative to the axis of rotation projected into the respective individual layer (n=1 to N), wherein, proceeding from the starting layer (n=1) to the end layer (n=N), the angle differences Δφₙ of the fibre angles φₙ of two successive individual layers (n=1 to N−1) are defined by the equation Δφₙ=φₙ₊₁−φₙ, where n=1 to N−1, and, for at least 80%, preferably at least 90%, of all angle differences Δφ₁ to Δφ_{N-1}, the condition Δφₙ≥0 is met.

### CROSS-REFERENCE TO RELATED APPLICATIONS

This application is a National Stage of International Application No. PCT/EP2016/001492, filed on Sep. 3, 2016, and published in German as WO2017/050416 A1 on Mar. 30, 2017. This application claims the priority to German Patent Application Nos. 20 2015 105 057.7, filed on Sep. 24, 2015 and 20 2015 105 815.2, filed on Nov. 2, 2015. The entire disclosures of the above applications are incorporated herein by reference.

### FIELD

The disclosure relates to a pressure container for storing gases or liquids under pressures above 200 bar having an elongate storage element comprising at least one rotationally symmetrical, preferably conical and/or cylindrical central portion, a plurality N or number N of individual layers each comprising at least one braided or wound reinforcing fibre, preferably at least two braided or wound reinforcing fibres, wherein the individual layers lie over one another in a local sequence along a perpendicular to the axis of rotation of the central portion, and wherein an inner starting layer surrounds a hollow body disposed within the storage element or forms said hollow body, and wherein an end layer disposed above the starting layer is provided, and wherein the reinforcing fibre or the reinforcing fibres in each of the individual layers forms or form a layer-dependent fibre angle φₙ relative to the axis of rotation projected into the respective individual layer.

### BACKGROUND

This section provides background information related to the present disclosure which is not necessarily prior art.

In such pressure containers a fibre angle of 54.7 degrees is considered as an optimal value in order to absorb the circumferential forces occurring in the individual layers by means of the reinforcing fibres. At the same time, it has been recognized that for thick-walled pressure containers the tangential elongation or circumferential elongation within the individual layers is not constant but changes from the starting layer to the end layer. This has the consequence that the reinforcement fibres of the inner individual layers are stressed more than the outer individual layers and, therefore, the reinforcing fibres are not optimally utilized.

One approach for solving this problem is described in US 2015/0192251 A1, which for this purpose provides the use of reinforcing fibres with different strengths in the individual layers. However, this approach is costly, error prone and associated with a high mechanical complexity due to the simultaneous or downstream processing of the different reinforcing fibres.

### SUMMARY

This section provides a general summary of the disclosure, and is not a comprehensive disclosure of its full scope or all of its features.

Thus, it is the object of the present disclosure to provide an alternative solution for an optimized utilization of the reinforcing fibres of a pressure container.

This object is achieved by a pressure container for storing gases or liquids under pressures above 200 bar having an elongate storage element comprising at least one rotationally symmetrical, preferably conical and/or cylindrical central portion, a plurality N or number N of individual layers each comprising at least one braided or wound reinforcing fibre, preferably at least two braided or wound reinforcing fibres, wherein the individual layers lie over one another in a local sequence along a perpendicular to the axis of rotation of the central portion, and wherein an inner starting layer surrounds a hollow body disposed within the storage element or forms said hollow body, and wherein an end layer disposed above the starting layer is provided, and wherein the reinforcing fibre or the reinforcing fibres in each of the individual layers forms or form a layer-dependent fibre angle φₙ relative to the axis of rotation projected into the respective individual layer, wherein proceeding from the starting layer to the end layer the angle differences Δφₙ of the fibre angles φₙ of two successive individual layers are defined by the equation

Δφₙ=φₙ₊₁−φₙ

wherein n=1 to N−1, and wherein for at least 80%, preferably at least 90%, of all angle differences Δφ₁ to Δφ_{N-1} the condition Δφₙ≥0 is met.

By means of the inventive condition a majority of the fibre angles increases monotonically from the starting layer up to the end layer in the successive individual layers. Due to this inventive fibre angle graduation the circumferential stresses or elongations which vary, preferably at constant fibre angle, with the distance to the axis of rotation, can be compensated so that in each individual layer the at least one reinforcing fibre, preferably the at least two reinforcing fibres, experiences or experience an approximately equal load, in particular strain, in the fibre direction. This allows as compared to the prior art the use the same kind of the at least one reinforcing fibre, preferably the at least two reinforcing fibres, for all individual layers, and thus enables a much cheaper and simple manufacture of the pressure container according to the disclosure.

Due to the optimized utilization of the reinforcing fibre or the reinforcing fibres the pressure container can be used for storing gases or liquids under pressures above 300 bar, 350 bar, 400 bar, 500 bar, 600 bar, 700 bar, 800 bar, 900 bar or 1000 bar.

The gases or liquids may in particular be gaseous or liquefied natural gas, liquid gas, propane gas and/or butane gas and/or gaseous or liquefied hydrogen.

The storage element may in particular comprise at least one rotationally symmetrical, cylindrical central portion and at least one of the individual layers may have a fibre angle φₙ of 54.7° or in the local sequence of the individual layers a fibre angle φₙ of 54.7° can be covered. Depending on the wall thickness of the pressure container, i.e. depending on the plurality of N or number N and the thickness of the individual layers, it is furthermore advantageous that the fibre angle of 54.7° considered as optimal at least in thin-walled pressure containers is present in at least one of the individual layers, or is covered at least between two individual layers, that is, two successive individual layers have a braid angle of less than 54.7° and greater than 54.7°. Preferably, the at least one of the individual layers or the area of the local sequence of the individual layers is located in a center region between the starting layer and the end layer.

The layer-dependent fibre angle φₙ of the individual layers may preferably increase monotonically and/or linearly from the starting layer to the end layer.

The initial fibre angle of the starting layer may be between 39° and 54°, preferably between 47° and 53°, advantageously between 49° and 52°. Said initial fibre angles have proved to be particularly suitable in experiments.

The end fibre angle of the end layer may be between 55° and 70°, preferably between 56° and 65°, advantageously between 57° to 60°. Said end fibre angles have proved to be particularly suitable in experiments.

The plurality N or number N of individual layers may be at least 15 individual layers, preferably at least 20 individual layers, more preferably at least 25 individual layers, most preferably at least 30 individual layers.

The at least one braided or wound reinforcing fibre, preferably the at least two braided or wound reinforcing fibres, of the individual layers may be embedded in a thermoplastic or a thermosetting matrix.

The at least one reinforcing fibre, preferably the at least two reinforcing fibres, of the individual layers can be formed by one or more glass fibre(s) and/or carbon fibre(s) and/or basalt fibre(s) and/or aramid fibre(s) and/or flax fibre(s) and/or jute fibre(s) and/or boron fibre(s) and/or sisal fibre(s) and/or ceramic fibre(s) and/or metal fibre(s).

Preferably the kind of the at least one reinforcing fibre, preferably the at least two reinforcing fibres, in the individual layers is identical.

Alternatively, the kind of the at least one reinforcing fibre, preferably the at least two reinforcing fibres, can vary within and/or among the individual layers. In this way an even better adaptation to the varying circumferential stresses or circumferential elongations is possible.

The at least one reinforcing fibre, preferably the at least two reinforcing fibres, may have a braided reinforcement fibre/braided reinforcing fibres and the fibre angle may be a fibre braid angle and the starting fibre angle may be a starting fibre braid angle and the end fibre angle may be an end fibre braid angle. The inventive configuration of the pressure container is particularly suitable for pressure containers with braided reinforcing fibres.

Preferably the at least one reinforcement fibre, preferably the at least two reinforcing fibres, is/are formed by a plurality of individual fibres or filaments. The at least one reinforcing fibre, preferably the at least two reinforcing fibres, can in particular be a bundle, strand or multifilament yarn of filaments preferably arranged in parallel.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

### EXEMPLARY EMBODIMENTS

In the following the disclosure will be explained with reference to the drawing which merely shows exemplary embodiments. In the drawings schematically:

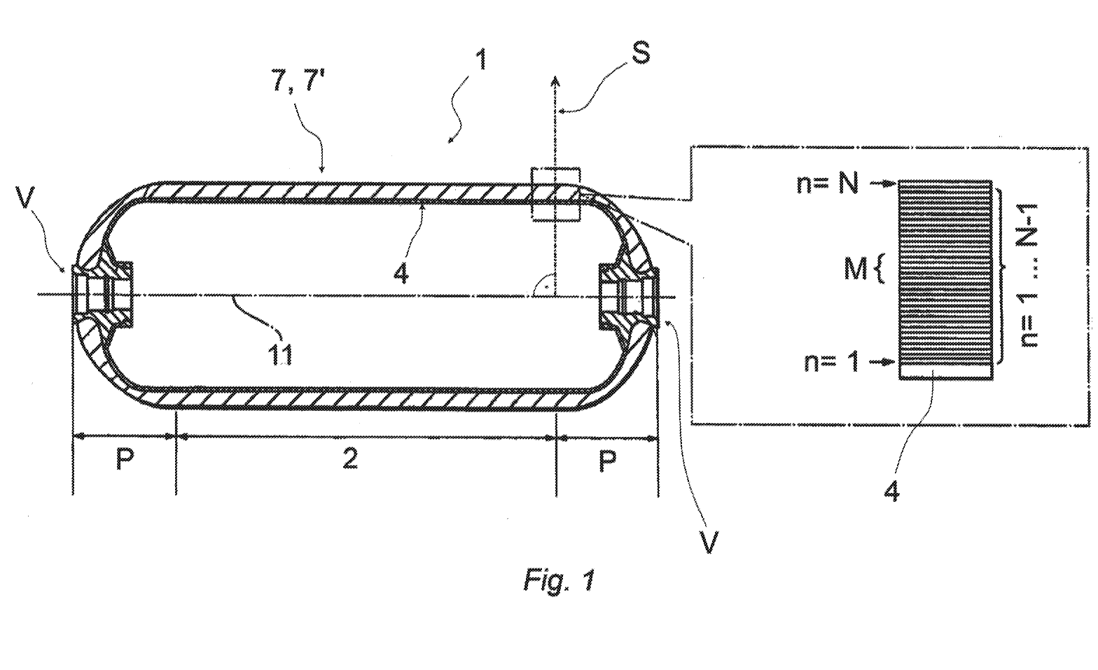

FIG. 1 is a cross sectional view of a pressure container;

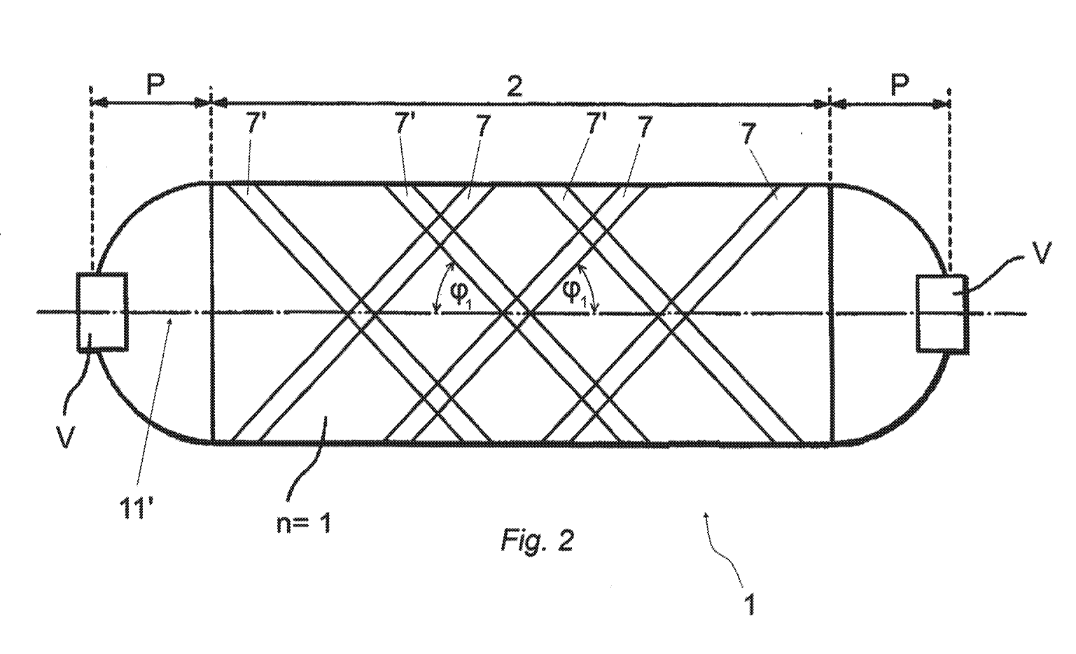

FIGS. 2-4 are plan views of various individual layers of a pressure container according to the disclosure; and

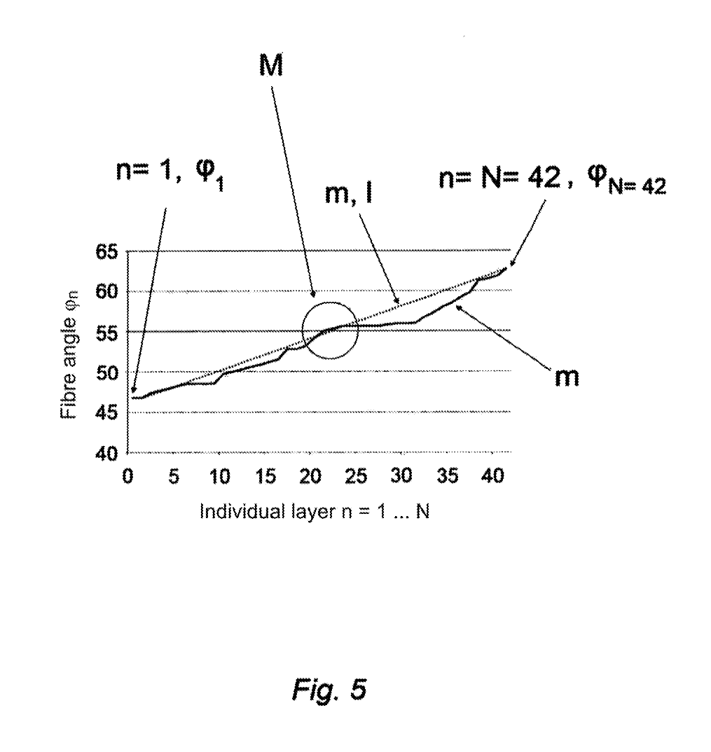

FIG. 5 is a diagram showing different fibre angles in the individual layers.

In the figures, identical or functionally identical elements are denoted with the same reference symbols.

Corresponding reference numerals indicate corresponding parts throughout the several views of the drawings.

### DETAILED DESCRIPTION

Example embodiments will now be described more fully with reference to the accompanying drawings.

FIG. 1 shows a cross-sectional view of a pressure container for storing gases or liquids under pressures above 200 bar, comprising an elongated storage element 1 having at least one rotationally symmetrical, preferably conical and/or cylindrical center portion 2. The storage element 1 also includes a plurality N or number N of individual layers n=1 to N (in the figure denoted by 1 . . . N), which each comprise at least one braided or wound reinforcing fibre 7, 7′, preferably at least two braided or wound reinforcing fibres 7, 7′, wherein the individual layers of n=1 to N lie over one another in a local sequence along a perpendicular S to the axis of rotation 11 of the central portion 2. In other words, the individual layers n=1 to N lie over one another in the radial direction. An inner starting layer n=1 surrounds a hollow body 4 disposed within the storage element. The hollow body 4 can in particular consist of a thermoplastic material. The thermoplastic material of the hollow body 4 may comprise polyamide or cross-linked polyethylene. Alternatively, the inner starting layer can form this hollow body n=1 by itself. An end layer n=N is disposed above the starting layer n=1. The storage element 1 has a rotationally symmetrical, cylindrical center portion 2. The center portion 2 is located between two pole caps P in each of which a valve portion V is arranged.

FIGS. 2 to 4 are plan views of various individual layers n=1 to N of the pressure container and the storage element 1 of FIG. 1, respectively. The reinforcing fibre 7, 7′ or the reinforcement fibres 7, 7′ in each of the individual layers n=1 to N shown has/have a layer-dependent fibre angle φₙ relative to the axis of rotation 11′ projected into the respective individual layer n=1 to N.

FIG. 2 shows the starting layer n=1, in which the at least one reinforcing fibre 7, 7′, preferably the at least two reinforcing fibres 7, 7′, has/have the starting fibre angle φᵢ between 39° to 53°.

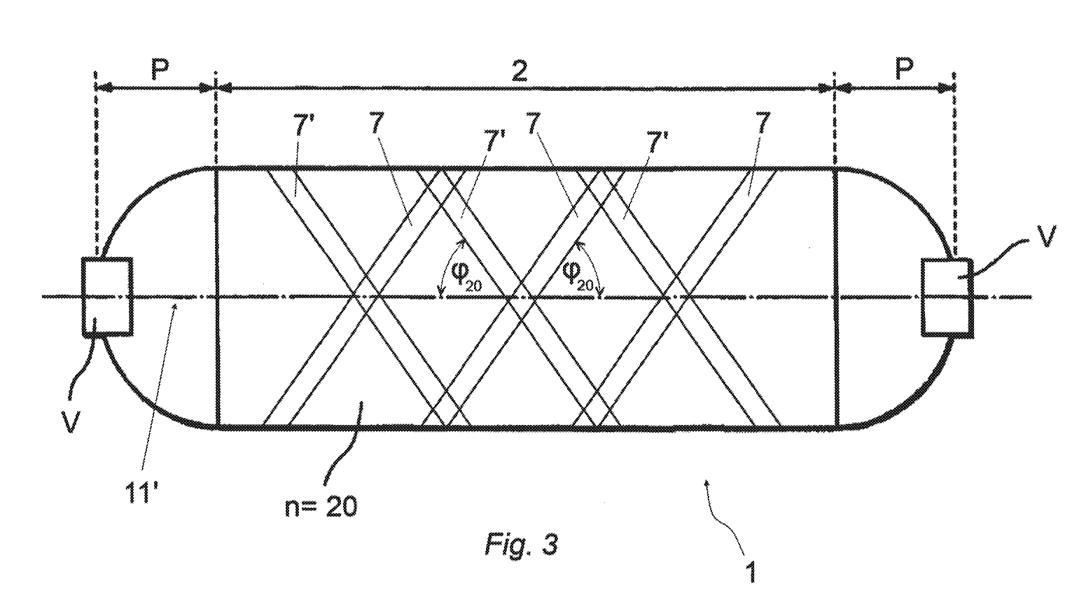

FIG. 3 shows one of the individual layers n=20 which has/have a fibre angle φ₂₀ of 54.7° or which reinforcing fibre(s) 7, 7′ has/have a fibre angle φ₂₀ of 54.7°. This individual layer n=20 is located in a central region M (see FIG. 1) between the starting layer n=1 and the end layer n=N.

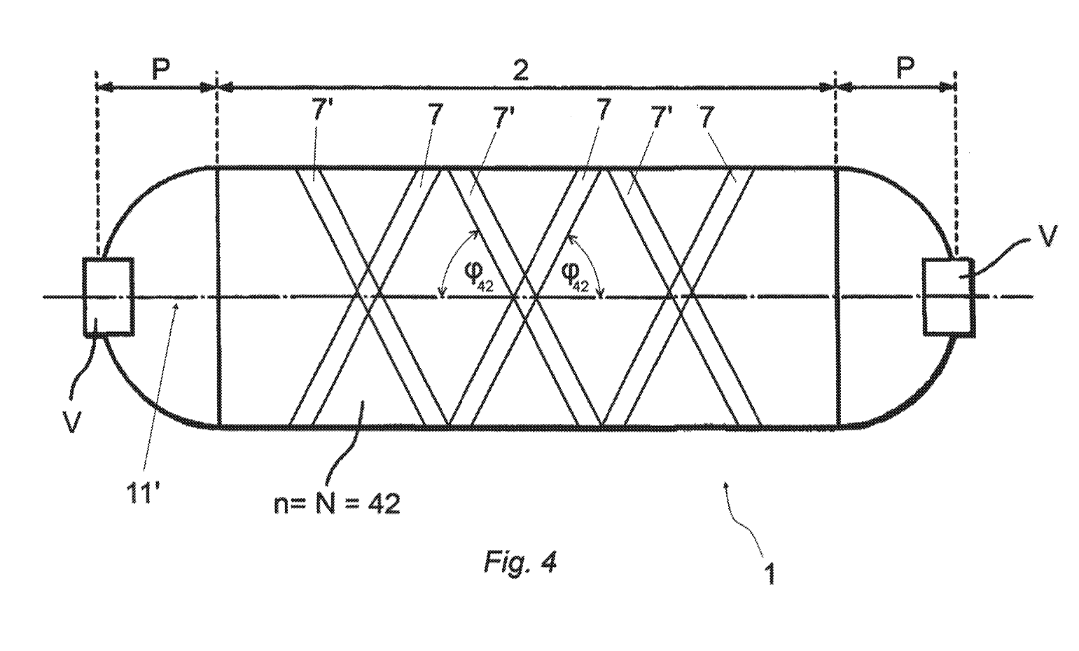

FIG. 4 shows the end layer n=N=42, wherein the end fibre angle φ_{N=42} of the end layer n=N=42 or of the reinforcing fibre(s) 7, 7′ is between 55° and 70°.

FIG. 5 is a diagram showing two possible sequences of the braid angle φₙ in the various individual layers n=1 to N of the pressure container shown in FIGS. 1 to 4. In both of the two cases proceeding from the starting layer n=1 to the end layer n=N the angle differences Δφₙ of the fibre angles φₙ of two successive individual layers n=1 to n=N are defined by the equation

Δφₙ=φₙ₊₁−φₙ,

wherein n=1 to N−1, and wherein for at least 80%, preferably at least 90% of all angle differences Δφ₁ to Δφ_{N-1} the condition Δφₙ≥0 is met.

The layer-dependent fibre angle φₙ of the individual layers n=1 to N may for example increase monotonically m or linearly l from the starting layer n=1 to the end layer n=N.

The plurality N or number N of individual layers of n=1 to N of the pressure container may be at least 15 individual layers, preferably at least 20 individual layers, more preferably at least 25 individual layers, and most preferably at least 30 individual layers. In the example shown, the plurality N or number N of individual layers is 42 individual layers.

The at least one braided or wound reinforcing fibre 7, 7′, preferably the at least two braided or wound reinforcing fibres 7, 7′, of the individual layers n=1 to N can be embedded in a thermoplastic or a thermosetting matrix. The thermosetting matrix may in particular comprise an epoxide, polyurethane, aminoplast, phenol resin, cross-linked polyacrylate, melamine resin or mixtures of the aforementioned materials. The thermoplastic matrix may comprise in particular polysulphone (PSU), polyethersulfone (PES), polyetherimide (PEI), polyphenylene sulfide (PPS), polyphenylene sulfone (PPSU), polyether ether ketone (PEEK), polyether ketones (PEK), polyimide imide (PAI), poly-m-phenylene isophthalamide (PMI), polyphthalam ides (PPA), polybenzimidazoles (PBI), polytetrafluoroethylene (PTFE), perfluoroalkoxylalkane (PFA), polyoxymethylene (POM), polyimide (PA), polyethylene terephthalate (PET), polybutylene terephthalate (PBT), polymethyl methacrylate (PMMA), polystyrene (PS), syndiotactic polystyrene (sPS), polycarbonate (PC), styrene-acrylonitrile copolymer (SAN), polyphenylene ether (PPE), polyvinyl chloride (PVC), polyethylene (PE), polypropylene (PP), acrylonitrile-butadiene-styrene (ABS) or mixtures of the aforementioned materials.

The at least one reinforcing fibre 7, 7′, preferably the at least two reinforcement fibres 7, 7′, of the individual layers n=1 to N can be formed by one or more glass fibre(s) and/or carbon fibre(s) and/or basalt fibre(s) and/or aramid fibre(s) and/or flax fibre(s) and/or jute fibre(s) and/or boron fibre(s) and/or sisal fibre(s) and/or ceramic fibre(s) and/or metal fibre(s).

The kind of the at least one reinforcing fibre 7, 7′ or the at least two reinforcement fibres 7, 7′ in the individual layers n=1 to N is identical.

The at least one reinforcing fibre 7, 7′, preferably the at least two reinforcing fibres 7, 7′, shown in FIGS. 1 to 5 can in particular be a braided reinforcement fibre 7, 7′, preferably at least two braided reinforcement fibres 7, 7′, and the fibre angle φₙ may be a fibre braid angle and the starting fibre angle φᵢ may be a starting fibre braid angle and the end fibre angle φ_{N} may be an end fibre braid angle.

The at least one reinforcing fibre 7, 7′, preferably the at least two reinforcing fibres 7, 7′, shown in FIGS. 1 to 5 can be formed by a plurality of individual fibres or filaments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are to be regarded as a departure from the disclosure, and all such modifications are intended to be included within the scope of the disclosure.

1. A pressure container for storing gases or liquids under pressures above 200 bar, having an elongate storage element comprising:
at least one rotationally symmetrical, preferably conical and/or cylindrical central portion; and
a plurality (N) or number (N) of individual layers (n=1 to N) each having at least one braided or wound reinforcing fibre, preferably at least two braided or wound reinforcing fibres, wherein the individual layers (n=1 to N) lie over one another in a local sequence along a perpendicular (S) to the axis of rotation of the central portion,
wherein an inner starting layer (n=1) surrounds a hollow body disposed within the storage element or forms said hollow body,
an end layer (n=N) disposed above the starting layer (n=1) is provided, and
the reinforcing fibre or the reinforcing fibres in each of the individual layers (n=1 to N) has/have a layer-dependent fibre angle φₙ relative to the axis of rotation projected into the respective individual layer (n=1 to N);
wherein,
proceeding from the starting layer (n=1) to the end layer (n=N) the angle differences Δφₙ of the fibre angles φₙ of two successive individual layers (n=1 to n=N−1) are defined by the equation
Δφₙ=φₙ₊₁−φₙ
wherein n=1 to N−1, and wherein for at least 80%, preferably at least 90%, of all angle differences Δφ₁ to Δφ_{N-1} the condition Δφₙ≥0 is met.

2. The pressure container according to claim 1, wherein the storage element comprises at least one rotationally symmetrical, cylindrical central portion and at least one of the individual layers (n=1 to N) has a fibre angle φₙ of 54.7° or in the local sequence of the individual layers (n=1 to N) a fibre angle φₙ of 54.7° is covered.

3. The pressure container according to claim 2, wherein the at least one of the individual layers (n=1 to N) or the area of the local sequence of the individual layers (n=1 to N) is disposed within a central portion (M) between the starting layer (n=1) and the end layer (n=N).

4. The pressure container according to claim 1, wherein the layer-dependent fibre angle φₙ of the individual layers (n=1 to N) increases monotonically (m) or linearly (l) from the starting layer (n=1) to the end layer (n=N).

5. The pressure container according to claim 1, wherein the starting fibre angle (φᵢ) of the starting layer (n=1) is between 39° and 54°, preferably between 47° and 53°, more preferably between 49° and 52°.

6. The pressure container according to claim 1, wherein the end fibre angle (φ_{N}) of the end layer (n=N) is between 55° and 70°, preferably between 56° to 65°, more preferably between 57° and 60°.

7. The pressure container according to claim 1, wherein the plurality (N) or number (N) of individual layers (n=1 to N) is at least 15 individual layers, preferably at least 20 individual layers, more preferably at least 25 individual layers, most preferably at least 30 individual layers.

8. The pressure container according to claim 1, wherein the at least one braided or wound reinforcing fibre, preferably the at least two braided or wound reinforcing fibres, of the individual layers (n=1 to N) is/are embedded in a thermoplastic or thermosetting matrix.

9. The pressure container according to claim 1, characterized in that wherein the at least one reinforcement fibre, preferably the at least two reinforcing fibres, of the individual layers (n=1 to N) is/are formed by one or more glass fibre(s) and/or carbon fibre(s) and/or basalt fibre(s) and/or aramid fibre(s).

10. The pressure container according to claim 1, wherein the kind of the at least one reinforcing fibre, preferably the at least two reinforcing fibres, in the individual layers (n=1 to N) is identical.

11. The pressure container according to claim 1, wherein the kind of the at least one reinforcing fibre, preferably the at least two reinforcing fibres, inside and/or among the individual layers (n=1 to N) is different.

12. The pressure container according to claim 1, wherein the at least one reinforcement fibre, preferably the at least two reinforcing fibres, is/are a braided reinforcement fibre, preferably at least two braided reinforcing fibres, and the fibre angle (φₙ) is a fibre braid angle and the starting fibre angle (φᵢ) is a starting fibre braid angle and end fibre angle (φ_{N}) is an end fibre braid angle.

13. The pressure container according to claim 1, wherein the at least one reinforcement fibre, preferably the at least two reinforcing fibres, is/are formed by a plurality of individual fibres or filaments.
